(19) United States
(12) Patent Application Publication
(10) Pub. No.: US 2026/0212460 A1
(43) Pub. Date: Jul. 23, 2026

(54) Image Noise Reduction based on Human Vision Perception

(71) Applicant: Google LLC, Mountain View, CA (US)

(72) Inventors: Hee jun Park, San Diego, CA (US); Amin Khajeh, Los Altos Hills, CA (US); Jun Nishimura, Cupertino, CA (US)

(21) Appl. No.: 19/139,527

(22) PCT Filed: Dec. 16, 2022
(86) PCT No.: PCT/US2022/081788

§ 371 Date: Jun. 16, 2025

(51) Int. Cl. G06T 5/70; G06T 7/00

(52) U.S. Cl. CPC G06T 5/70; G06T 7/0002; G06T 2207/20021; G06T 2207/30168

(57) ABSTRACT

A method includes applying a human perception model to determine a respective measure of noise perception for each tile of a. plurality of tiles of an image captured by an image capturing device. The method further includes determining, by a workload budget manager, a number of tiles of the image to process for noise reduction. The method additionally includes selecting at most the determined number of tiles from the plurality of tiles of the image based on the respective measure of noise perception determined for each tile of the plurality of tiles of the image. The method also includes applying one or more noise reduction processes to the selected tiles to produce a perception-optimized image. The method, additionally includes causing the image capturing device to display the perception-optimized image.

### BACKGROUND

Many modern computing devices, including mobile phones, personal computers, and tablets, are image capturing devices. Such devices may apply noise reduction processes, including temporal noise reduction (TNR) and spatial noise reduction, to reduce noise when processing captured images. Image capturing devices may process each captured image frame with such noise reduction processes, which in some cases may cause undesirable impact on the devices in terms of thermal condition, battery life, and device performance. Some such systems may not adequately take into consideration image contents and human vision perception.

### SUMMARY

Example systems and methods described herein may improve the performance of an image capturing device which is using one or more noise reduction processes (temporal noise reduction and/or spatial noise reduction). A captured image may be divided into image tiles. For each image tile, a human perception model may be used to determine a measure of noise perception for the contents of the image tile. Additionally, a workload budget manager may determine how many of the tiles may be processed for noise reduction. At most the determined number of image tiles may be selected based on the results of applying the human perception model. One or more noise reduction processes may then be applied to the selected tiles to create a perception-optimized image.

In an embodiment, a method is disclosed which includes applying a human perception model to determine a respective measure of noise perception for each tile of a plurality of tiles of an image captured by an image capturing device. The method further includes determining, by a workload budget manager, a number of tiles of the image to process for noise reduction. The method additionally includes selecting at most the determined number of tiles from the plurality of tiles of the image based on the respective measure of noise perception determined for each tile of the plurality of tiles of the image. The method also includes applying one or more noise reduction processes to the selected tiles to produce a perception-optimized image. The method additionally includes causing the image capturing device to display the perception-optimized image.

In a further embodiment, an image capturing device is disclosed comprising one or more processors and one or more non-transitory computer readable media storing program instructions executable by the one or more processors to perform operations. The operations include applying a human perception model to determine a respective measure of noise perception for each tile of a plurality of tiles of an image captured by the image capturing device. The operations additionally include determining, by a workload budget manager, a number of tiles of the image to process for noise reduction. The operations further include selecting at most the determined number of tiles from the plurality of tiles of the image based on the respective measure of noise perception determined for each tile of the plurality of tiles of the image. The operations additionally include applying one or more noise reduction processes to the selected tiles to produce a perception-optimized image. The operations also include causing the image capturing device to display the perception-optimized image.

In a further embodiment, one or more non-transitory computer readable media storing program instructions are disclosed which are executable by one or more processors to perform operations. The operations include applying a human perception model to determine a respective measure of noise perception for each tile of a plurality of tiles of an image captured by the image capturing device. The operations additionally include determining, by a workload budget manager, a number of tiles of the image to process for noise reduction. The operations further include selecting at most the determined number of tiles from the plurality of tiles of the image based on the respective measure of noise perception determined for each tile of the plurality of tiles of the image. The operations additionally include applying one or more noise reduction processes to the selected tiles to produce a perception-optimized image. The operations also include causing the image capturing device to display the perception-optimized image.

In a further embodiment, a system is provided that includes means for applying a human perception model to determine a respective measure of noise perception for each tile of a plurality of tiles of an image captured by the image capturing device. The system additionally includes means for determining, by a workload budget manager, a number of tiles of the image to process for noise reduction. The system further includes means for selecting at most the determined number of tiles from the plurality of tiles of the image based on the respective measure of noise perception determined for each tile of the plurality of tiles of the image. The system additionally includes means for applying one or more noise reduction processes to the selected tiles to produce a perception-optimized image. The system also includes means for causing the image capturing device to display the perception-optimized image.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example video capturing device, in accordance with example embodiments.

FIG. 2 is a simplified block diagram showing some of the components of an example video capturing device, in accordance with example embodiments.

FIG. 3 is a diagram illustrating selective application of noise reduction processes, in accordance with example embodiments.

FIG. 4 is a block diagram illustrating per-tile selective application of noise reduction processes, in accordance with example embodiments.

FIG. 5 is a plot of signal-noise ratio relative to luminance, in accordance with example embodiments.

FIG. 6 is a plot of contrast sensitivity relative to temporal frequency and spatial frequency, in accordance with example embodiments.

FIG. 7 and FIG. 8 are diagrams illustrating a human temporal noise perception model, in accordance with example embodiments.

FIG. 9 illustrates a tile prioritizer, in accordance with example embodiments.

FIG. 10 illustrates per-tile selective noise reduction processing, in accordance with example embodiments.

FIG. 11 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

An image capturing device, such as a digital camera, smartphone, or laptop computer, may include one or more image sensors (e.g., cameras) configured to capture images representing the surrounding environment of the image capturing device. The images may be still images and/or image frames of video data. Captured images may include undesirable noise which may limit the viewing quality of the images. The noise may include temporal noise, fluctuations which vary over time from image frame to image frame. The noise may also include spatial noise, distortion over an image area which is stable over time. Temporal noise reduction and/or spatial noise reduction processes may be used by an image capturing device to reduce the noise. In some cases, the computational load of noise reduction processing may be significant, causing excessive battery utilization, device overheating, and/or other operational limitations. Solutions which apply noise reduction processes to entire images or image frames may therefore be undesirable.

Examples described herein provide improved processing efficiency for an image capturing device applying one or more noise reduction processes. More specifically, temporal and/or spatial noise reduction hardware and/or software may selectively process image tiles of captured images or image frames based on a human vision model of temporal noise perception. As described herein, the human vision model may calculate a degree of temporal noise perception based on one or more factors related to a captured image and/or the image capturing device. Such factors may include, for example, image luminance, image contrast, image motion speed, device frames per second (FPS), and/or a ratio of image sensor output resolution relative to input resolution. An approach described herein may significantly reduce power consumption and/or processing latency of temporal and/or spatial noise reduction with minimal or imperceptible image quality impact.

Example methodology described herein may include four sub-components. Such sub-components may be implemented as hardware blocks and/or software functions. A first sub-component may be a human perception model of temporal noise. The human perception model may produce a respective measure of noise perception for each image tile (e.g., grid or block or region) of a captured image. In some examples, the human perception model may determine a function of a number of per-tile image measurements. The function may be a simple linear weighted sum or sophisticated nonlinear. In further examples, the human perception model may be a machine learned model applied to one or more per-tile image measurements, where the machine learned model has been trained based on user-annotated image data.

A second sub-component may be a workload budget manager. The workload budget manager may determine a maximum number of image tiles of the image to process for noise reduction. The number of image tiles may be less than the full image to enable computational benefits associated with reduced processing. The workload budget manager may consider one or more factors to determine a maximum number of image tiles to process with noise reduction. Such factors may include, for example, a state of battery charge of the image capturing device, a system power budget for the image capturing device, a thermal condition of the image capturing device, and/or a performance condition of the image capturing device.

A third sub-component may be a tile prioritizer. The tile prioritizer may select an appropriate number of image tiles to process for noise reduction based on outputs from the human perception model and the workload budget manager. In some examples, the tile prioritizer may first sort the tiles in order based on the respective measure of noise perception indicated by the human perception model for each image tile of an image. The tile prioritizer may then select a number of tiles from the sorted list, with the number of selected tiles being at most the number tiles the workload budget manager allocated.

A fourth sub-component may be per-tile selective noise reduction processing. More specifically, once a particular subset of the image tiles are selected for noise reduction by the tile prioritizer, the noise reduction processing may then be applied only to the selected image tiles (as opposed to entire images or image frames). This per-tile selective noise reduction processing may involve applying one or more temporal noise reduction processes and/or one or more spatial noise reduction processes. The resulting processed image tiles may be used to generate a perception-optimized image (or image frame of a video) to display on the image capturing device.

### II. Example Systems and Methods

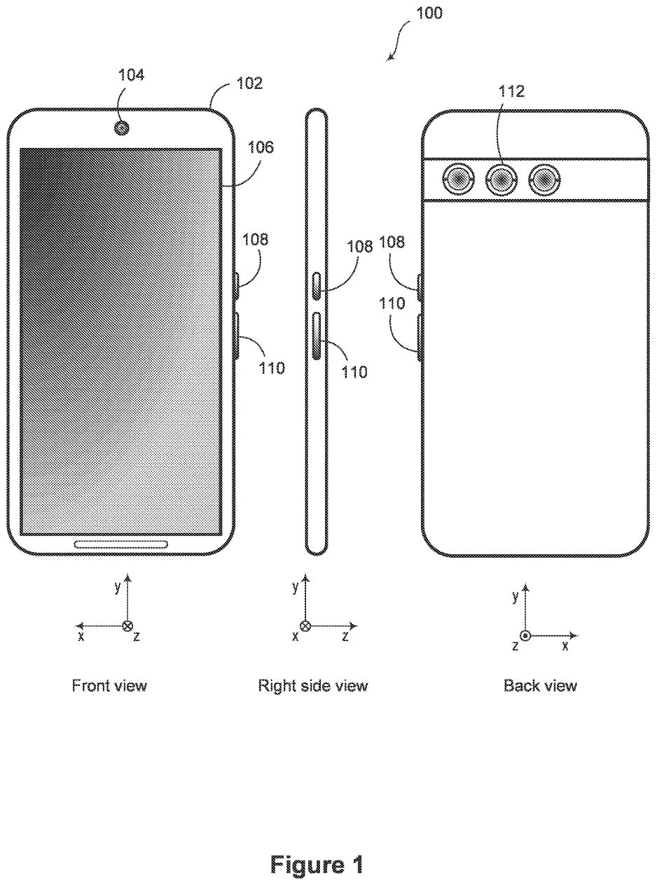

FIG. 1 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

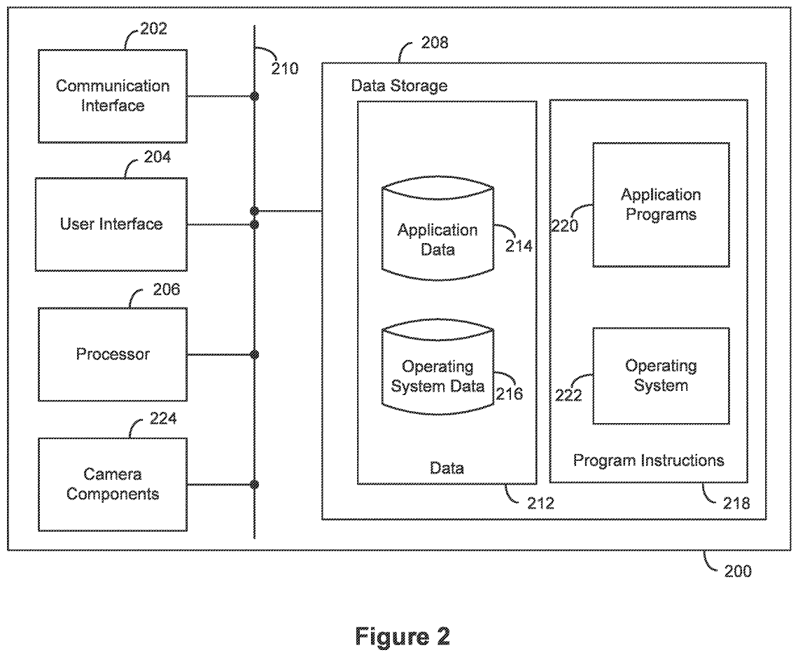

FIG. 2 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

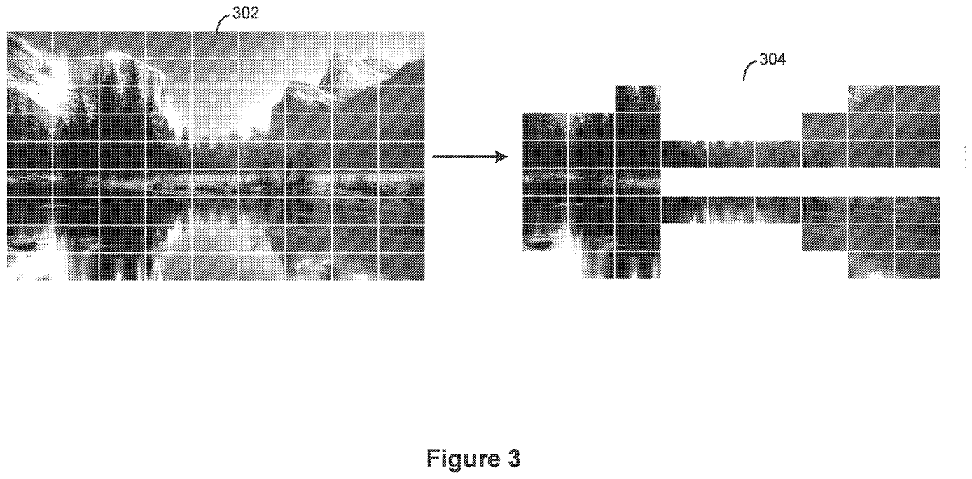

FIG. 3 is a diagram illustrating selective application of noise reduction processes, in accordance with example embodiments. More specifically, an image 302 captured by an image capturing device may in some examples be processed for temporal and/or spatial noise reduction. Some systems may process the entire image 302 (e.g., uniformly process each of the illustrated image tiles of the image 302). However, such systems may limit performance of the image capturing device and cause excessive power consumption, battery utilization, latency, and/or other performance limitations.

Image 304 illustrates a selection of tiles from image 302. More specifically, the illustrated image tiles 304 may be selected for processing with one or more noise reduction processes. Meanwhile, the noise reduction processes may be omitted for the other image tiles of image 302. The selected image tiles of image 304 may be selected as tiles which have noise which is more perceivable by human vision perception. Accordingly, by processing only the image tiles of image 304, computational costs may be reduced with minimal impact on perceived image quality.

FIG. 3 illustrates an example arrangement in which the image 302 is divided into 9×9=81 image tiles, of which 37 image tiles are selected for processing for noise reduction. The number of selected tiles may be adjusted dynamically by a workload budget manager based on current operating conditions of the image capturing devices. In some examples, the total number of tiles for a captured image may be set to a predetermined number (e.g., 9×9=81 tiles, as illustrated in FIG. 3). In further examples, the number of tiles to divide the image into may also be adjusted dynamically based on current operating conditions of the image capturing device and/or based on other factors (e.g., contents of the particular captured image).

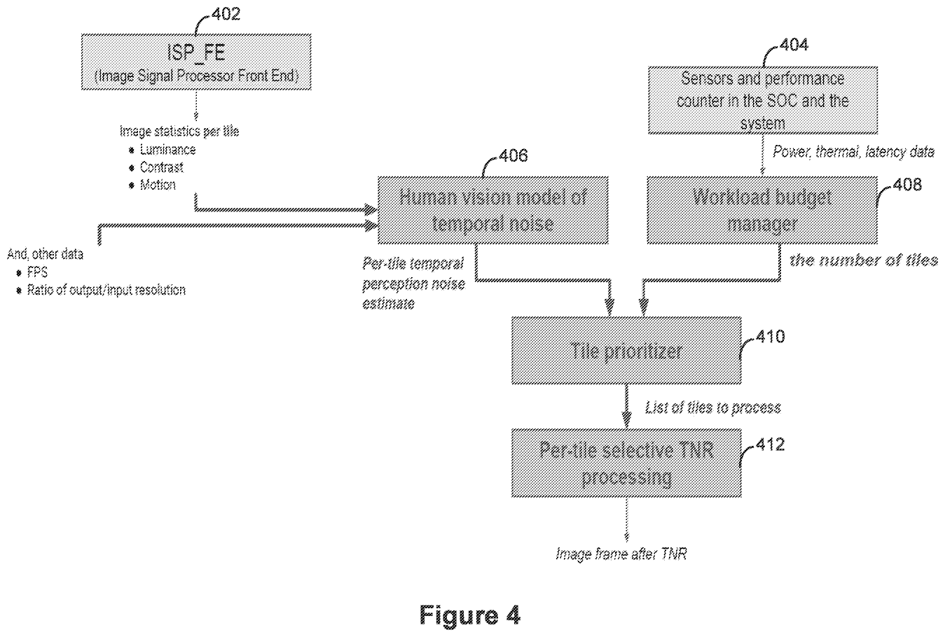

FIG. 4 is a block diagram illustrating per-tile selective application of noise reduction processes, in accordance with example embodiments. More specifically, four hardware and/or software sub-components of an example system are illustrated, including a human vision model of temporal noise block 406, a workload budget manager block 408, a tile prioritizer block 410, and a per-tile selective TNR processing block 412.

Inputs to the human vision model of temporal noise block 406 may include per-tile image statistics provided by image signal processor front end (ISP_FE) 402. Example per-tile image statistics may include a measure of luminance, a measure of contrast, and/or a measure of motion speed. The measure of luminance may indicate average brightness level or light signal strength for an image tile. The measure of contrast may indicate a delta of luminance and/or colors for the image tile. The measure of motion of speed may indicate moving speed of objects and/or background for the image tile. The per-tile statistics may be determined separately for each image tile of each captured image (or captured image frame of a video) in order to enable the human vision model of temporal noise block 406 to determine a measure of noise perception for each tile in the image.

In some examples, inputs to the human vision model of temporal noise block 406 may also include data related to the image capturing device. Such data may be configuration information for the image capturing device. For instance, an input may be a frames per second (FPS) measurement for a display of the image capturing device. In further examples, an input may be a ratio of output to input resolution (e.g., a scale-down ratio from the input image to an output image). More specifically, image resolution scale-down tends to reduce temporal noise by averaging several pixels spatially, reducing the need for noise reduction processes. In some examples, the human vision model of temporal noise block 406 may be configured to combine both per-tile information from ISP_FE 402 and configuration information for the image capturing device in order to produce a per-tile temporal perception noise estimate.

The workload budget manager block 408 may receive inputs indicative of the status of the image capturing device. More specifically, one or more device sensors and/or performance counters in the System on Chip (SOC) or device system may provide current device statistics that may be processed by the workload budget manager block 408 to determine a maximum number of image tiles to process for noise reduction. Example device statistics include a system power budget, a measure of latency, and a state of battery charge of the image capturing device. Depending on the device statistics and current operating conditions, the workload budget manager block 408 may determine that the device can only afford to process a certain number of tiles for noise reduction without excessive strain on device performance.

The tile prioritizer block 410 may take as input the per-tile temporal perception noise estimate from the human vision model of temporal noise block 406 and the number of tiles to process from the workload budget manager block 408. Based on these two inputs, the tile prioritizer block 410 may produce a list of image tiles to process for noise reduction. For instance, the tile prioritizer block 410 may sort all of the image tiles according to the per-tile temporal perception noise estimates, and then select the top scoring tiles such that the selected number of tiles is at most the number of tiles indicated by the workload budget manager 408.

The per-tile selective TNR processing block 412 may receive the list of tiles to process from the tile prioritizer 410, and then apply one or more TNR processes only to those selected tiles. For instance, a TNR algorithm which blends image data over several frames to smooth out the data may be applied only to the selected tiles. The per-tile selective TNR processing block 412 may then output an image frame after selective application of the TNR processes (e.g., for display on the image capturing device). FIG. 4 provides an example implementation in the context of TNR. Alternative examples may involve selective application of spatial noise reduction processes as well or instead.

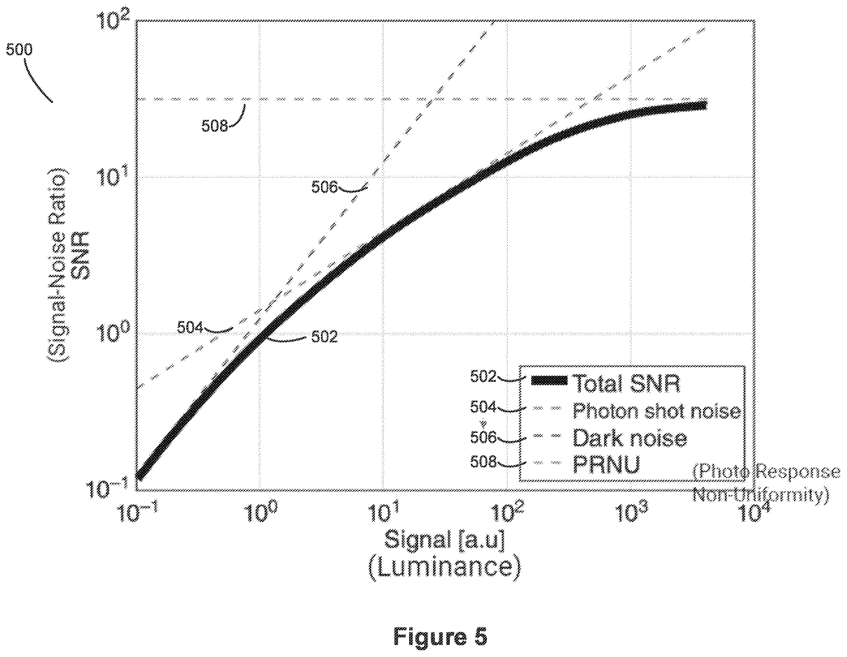

FIG. 5 is a plot of signal-noise ratio (SNR) relative to luminance, in accordance with example embodiments. More specifically, plot 500 shows how different components of image noise may vary relative to image luminance. As illustrated, both photon shot noise 504 and dark noise 506 increase with increasing luminance (e.g., brighter regions of an image). The photo response non-uniformity (PRNU) 508 is also illustrated, representing the uniformity of a particular camera's response to light. Based on these factors, an example SNR 502 is illustrated for different luminance values.

Notably, as plot 500 indicates, temporal noise is less perceivable or not perceivable at all in brighter regions of an image, due to the higher SNR. Meanwhile, temporal noise is more perceived in darker regions of the image, due to the lower SNR. Consequently, in examples described herein, TNR processing may be omitted for darker regions because of the minimal or small benefit of TNR processing.

Some example systems described herein may only consider luminance as a per-tile statistic for a human perception model to determine a measure of noise perception for each image tile. In further examples, other factors may be considered as well or instead. In particular, in addition to brighter (high light) regions, temporal noise is also less perceptible in high contrast regions and in fast motion regions.

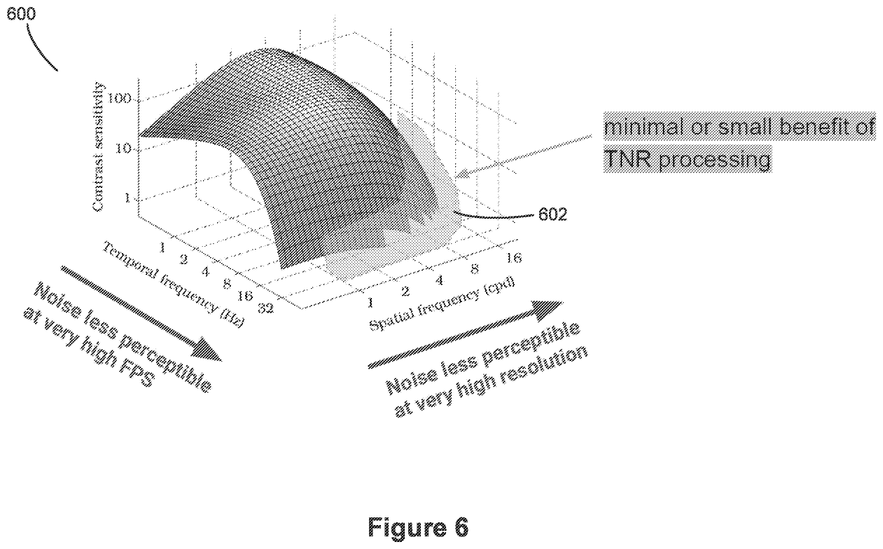

FIG. 6 is a plot of contrast sensitivity relative to temporal frequency and spatial frequency, in accordance with example embodiments. Plot 600 illustrates how noise becomes less perceptible at very high temporal frequency (high FPS) and at very high spatial frequency (high resolution). Accordingly, depending on configuration settings of an image capturing device, the device may be operating in region 602, where there is minimal benefit of TNR processing.

In some examples, a human perception model may consider these factors in assigning measures of noise perception to tiles, which ultimately may be used to drive determinations about whether or not to apply one or more noise reduction processes to the tiles. For instance, a tile prioritizer may elect to not prioritize noise reduction in image tiles for images captured with image capturing device settings which indicate that temporal noise is unlikely to be perceivable. In some examples, the tile prioritizer may be configured to select a fewer number of tiles for noise reduction processing than allowed by a workload budget manager when additional noise reduction processes are unlikely to be significantly beneficial. For instance, the tile prioritizer may select up the budgeted number of tiles for noise reduction processing, provided that each of the selected tiles has at least a threshold measure of noise perception determined by a human perception model.

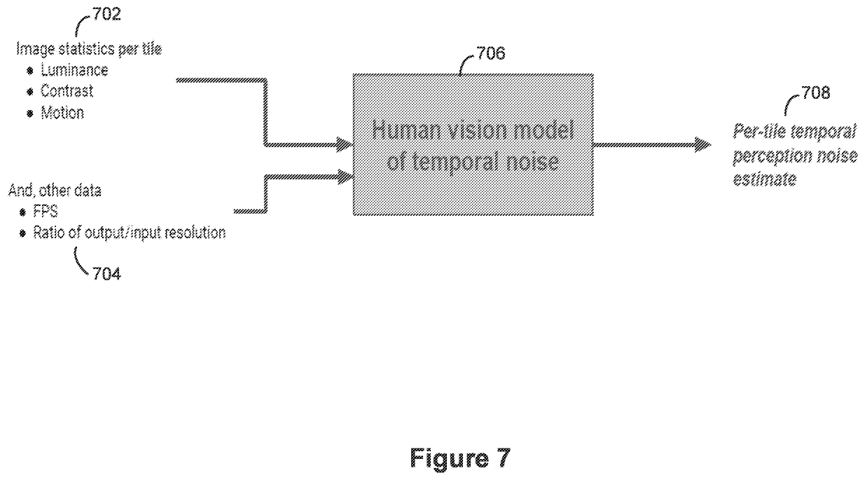

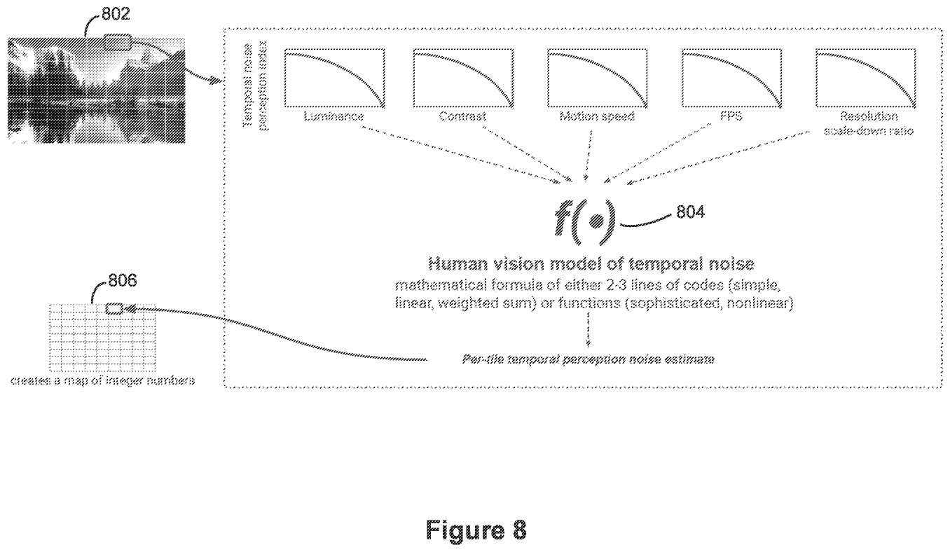

FIG. 7 and FIG. 8 are diagrams illustrating a human temporal noise perception model, in accordance with example embodiments. FIG. 7 illustrates that a human vision model of temporal noise 706 may take inputs that include image statistics per tile 702 (e.g., luminance, contrast, and/or motion) and other data 704 (e.g., FPS, ratio of output/input resolution) to generate a per-tile temporal perception noise estimate 708. More specifically, the per-tile temporal perception noise estimate 708 may be generated in the form of a map of integer numbers, with each integer number indicating the degree of temporal noise perception of each tile.

FIG. 8 illustrates an example implementation of the human vision model of temporal noise 706 from FIG. 7. More specifically, FIG. 8 illustrates inputs into a function 804, with the inputs corresponding to the inputs illustrated in FIG. 7 (luminance, contrast, motion speed, FPS, resolution scale-down ratio). As illustrated in FIG. 8, the human vision model of temporal noise 804 may be implemented as a mathematical formula which produces a per-tile temporal noise estimate. In some examples, the model may be implemented as a linear, weighted sum of two or more different inputs. In other examples, the model may be implemented as a non-linear combination of two or more different inputs. In further examples, the model may instead be implemented as a machine learned model which has been trained based on user-annotated image data to take as input one or more per-tile image measurements and to output a per-tile temporal perception noise estimate. In such examples, the machine learning model may also be configured to take one or more configuration settings of the image capturing device as inputs as well.

As illustrated in FIG. 8, the human vision model of temporal noise 804 may operate on each image tile of an image 802. Accordingly, the human vision model of temporal noise 804 may produce a map of integer numbers 806 which contains a per-tile temporal perception noise estimate for each image tile of the image 802. In some examples, the map of integer numbers 806 may be provided to a tile prioritizer component which is configured to select particular tiles for noise reduction processing.

In some examples, a human perception model may also be based on a measure of saliency of each image tile of an image. The measure of saliency may indicate an estimation of human attention or eye-gazing. The measure of saliency may be used as an additional input, in addition to per-tile image statistics such as luminance, contrast, and motion speed. Noise reduction processes may opportunistically be omitted for areas of an image with lower saliency measures. To produce this measure of saliency, an image capturing device may implement a machine learned Visual Saliency Model.

The Visual Saliency Model may be implemented as one or more of a support vector machine (SVM), a recurrent neural network (RNN), a convolutional neural network (CNN), a dense neural network (DNN), one or more heuristics, other machine-learning techniques, a combination thereof, and so forth. The Visual Saliency Model may be iteratively trained, off-device, by exposure to training scenes, sequences, and/or events. For example, training may involve exposing the Visual Saliency Model to images (e.g., digital photographs), including user-drawn bounding boxes containing a visual saliency region (e.g., a region wherein one or more objects of particular interest to a user may reside). Exposure to images including user-drawn bounding boxes may facilitate training of the Visual Saliency Model to identify visual saliency regions within images. As a result of the training, the Visual Saliency Model can generate a visual saliency heatmap for a given image and produce a bounding box enclosing the region with the greatest probability of visual saliency. In this way, the Visual Saliency Model can predict visual saliency regions within images. After sufficient training, model compression using distillation can be implemented on the Visual Saliency Model enabling the selection of an optimal model architecture based on model latency and power consumption. The Visual Saliency Model can then be deployed to the CRM of a computing device as an independent module or otherwise implemented into the human perception model processes for generating measures of noise perception.

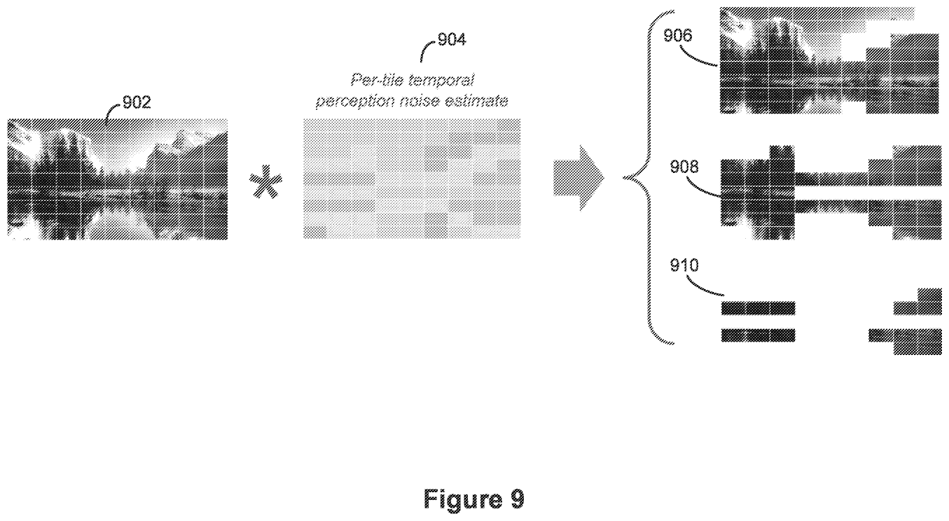

FIG. 9 illustrates a tile prioritizer, in accordance with example embodiments. A tile prioritizer component of an image capturing device may be configured to select image tiles for noise reduction processing (temporal noise reduction and/or spatial noise reduction). The tile prioritizer may be provided a captured image 902 as well as per-tile temporal perception noise estimates 904 from a human perception model. The per-tile temporal perception noise estimates 904 may be a matrix of values indicating the respective perception noise estimate for each image tile of the image 902. The tile prioritizer may be tasked with selecting a subset of the image tiles from the image 902 for noise reduction processing.

Additionally, a workload budget manager may determine a maximum number of tiles (e.g., a workload budget) that the noise reduction hardware and/or software can process. This determination may be based on SOC and/or system state measurements, such as power condition, thermal condition, and/or performance condition. The workload budget manager may provide the maximum number of tiles to the tile prioritizer to enable the tile prioritizer to select an acceptable number of tiles for noise reduction processing.

The tile prioritizer may sort the image tiles by temporal noise perception scores, and select tiles for noise reduction processing. In some examples, the tile prioritizer may select exactly the number of tiles indicated by the workload budget manager. In other examples, the tile prioritizer may be configured to select a number of tiles less than the workload budget in some cases. For instance, if a fewer number of tiles than the workload budget exceeds a threshold level of noise perception, only the fewer number of tiles may be selected by the tile prioritizer for noise reduction processing.

In one example, tiles 906 may be selected by the tile prioritizer for noise reduction processing. In this example, almost all of the tiles of image 902 may be selected by the tile prioritizer. This example may indicate that a relatively high workload budget was provided by the workload budget manager (indicating that the image capturing device is not under a particularly high level of strain in regards to power/thermal/performance condition). This example may further indicate that many of the tiles of image 902 have a relatively high measure of noise perception (indicating that there is a perception quality benefit to performing noise reduction processes on most of the image tiles of the image 902).

In another example, tiles 908 may be selected by the tile prioritizer for noise reduction processing. In this example, about half of the tiles of image 902 may be selected by the tile prioritizer. This example may indicate that a medium workload budget was provided by the workload budget manager (indicating that the image capturing device is under some strain in regards to power/thermal/performance condition). This example may further indicate that some of the tiles of image 902 have a relatively low measure of noise perception (indicating that there is little perception quality benefit to performing noise reduction processes on some of the image tiles of the image 902).

In a further example, tiles 910 may be selected by the tile prioritizer for noise reduction processing. In this example, relatively few of the tiles of image 902 may be selected by the tile prioritizer. This example may indicate that a low workload budget was provided by the workload budget manager (indicating that the image capturing device is under significant strain in regards to power/thermal/performance condition). This example may further indicate that many of the tiles of image 902 have a relatively low measure of noise perception (indicating that there is little perception quality benefit to performing noise reduction processes on many of the image tiles of the image 902).

The examples illustrated by tiles 906, 908, and 910 are intended to be exemplary. In other examples, a tile prioritizer may balance input from a workload budget manager and measures of noise perception from a human perception model in other manners in order to select particular tiles for noise reduction processing.

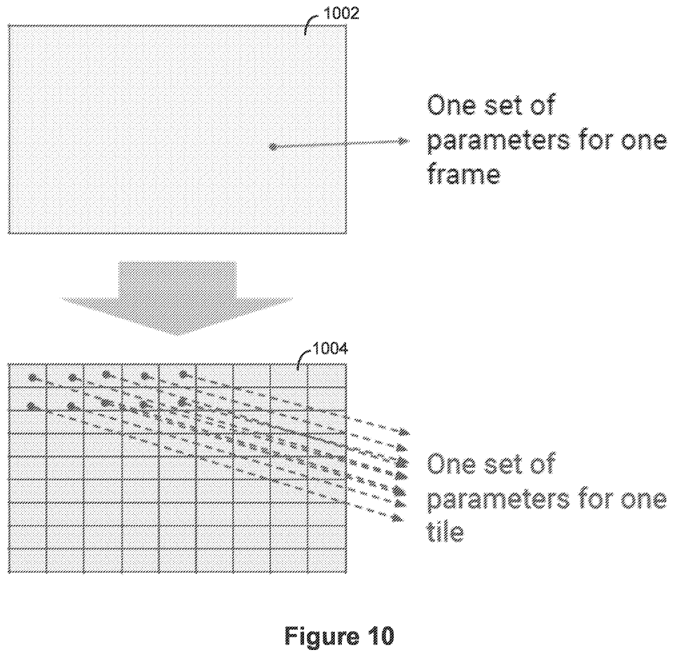

FIG. 10 illustrates per-tile selective noise reduction processing, in accordance with example embodiments. More specifically, some example systems may store only a single set of parameters 1002 per image frame indicating what processing to perform for the image frame. However, such example systems may perform an excessive amount of processing (e.g., noise reduction processing), which may overly burden performance of an image capturing device. By contrast, a separate set of parameters per image tile 1004 may be determined and stored to indicate what processing to perform for each image tile of an image frame. Per-tile sets of parameters 1004 may allow for opportunistic omission of noise reduction processing on at least some image tiles of an image frame.

In some examples, the per-tile sets of parameters 1004 may be stored in local registers of the image capturing device. In further examples, the per-tile sets of parameters 1004 may be stored in static random access memory (SRAM) of the image capturing device. In yet further examples, the per-tile sets of parameters 1004 may be stored in external double data rate (DDR) memory of the image capturing device. In some examples, the per-tile sets of parameters 1004 may be stored separately from the image tiles. In further examples, the per-tile sets of parameters 1004 may be stored as metadata together with the image tiles. In some examples, the per-tile sets of parameters 1004 may be loaded to a noise reduction processing unit per tile by hardware. In alternative examples, the per-tile sets of parameters 1004 may instead be loaded by software.

In some examples, the per-tile sets of parameters 1004 may at a minimum indicate whether to perform or skip noise reduction processing (e.g., temporal noise reduction and/or spatial noise reduction) for each of the tiles of an image. In further examples, the per-tile sets of parameters 1004 may indicate whether to determine both global and local motion vectors, or a global motion vector only. In further examples, the per-tile sets of parameters 1004 may indicate a motion vector resolution pyramid level (e.g., 1/2/3/4/5). In further examples, the per-tile sets of parameters 1004 may indicate whether to use Y only or YUV for a merge pixel. In further examples, the per-tile sets of parameters 1004 may indicate a number of frames to merge (e.g., 2/3/4). In additional examples, other processing settings may be determined and stored per-tile as well or instead.

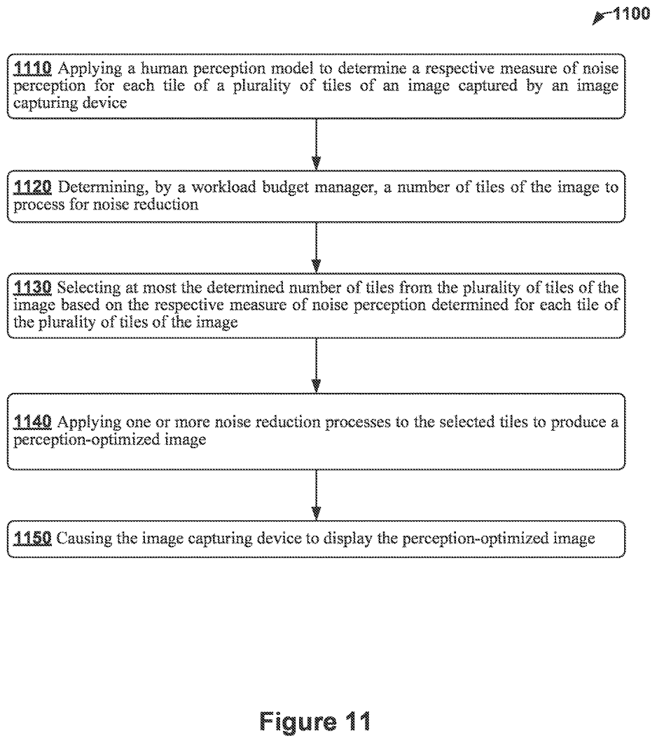

FIG. 11 is a flowchart of a method, in accordance with example embodiments. Method 1100 of FIG. 11 may be executed by one or more computing systems (e.g., computing system 200 of FIG. 2) and/or one or more processors (e.g., processor 206 of FIG. 2). Method 1100 may be carried out on a computing device, such as computing device 100 of FIG. 1. In some examples, each block of method 1100 may be performed locally on an image capturing device. In alternative examples, a portion or all of the blocks of method 1100 may be performed by one or more computing systems remote from an image capturing device.

At block 1110, method 1100 includes applying a human perception model to determine a respective measure of noise perception for each tile of a plurality of tiles of an image captured by an image capturing device.

At block 1120, method 1100 includes determining, by a workload budget manager, a number of tiles of the image to process for noise reduction.

At block 1130, method 1100 includes selecting at most the determined number of tiles from the plurality of tiles of the image based on the respective measure of noise perception determined for each tile of the plurality of tiles of the image.

At block 1140, method 1100 includes applying one or more noise reduction processes to the selected number of tiles to produce a perception-optimized image.

At block 1150, method 1100 includes causing the image capturing device to display the perception-optimized image.

In some examples, selecting at most the determined number of tiles from the plurality of tiles of the image based on the respective measure of noise perception determined for each tile of the plurality of tiles of the image comprises sorting the number of tiles in order based on the respective measure of noise perception determined for each tile of the plurality of tiles of the image.

In some examples, the respective measure of noise perception determined for each tile comprises a respective measure of temporal noise, and wherein the one or more noise reduction processes comprises one or more temporal noise reduction processes. In some examples, the respective measure of noise perception determined for each tile comprises a respective measure of spatial noise, and wherein the one or more noise reduction processes comprises one or more spatial noise reduction processes.

In some examples, applying the human perception model is based on a measure of luminance of each tile of the plurality of tiles of the image, a measure of contrast of each tile of the plurality of tiles of the image, a measure of motion speed of each tile of the plurality of tiles of the image, a measure of saliency of each tile of the plurality of tiles of the image, a frames per second (FPS) measurement for a display of the image capturing device, a ratio of output to input image resolution, and/or a measure of temporal frequency and a measure of spatial frequency.

In some examples, applying the human perception model involves determining a weighted sum or other function of a plurality of per-tile image measurements. In some examples, applying the human perception model involves applying a machine learned model to one or more per-tile image measurements, where the machine learned model has been trained based on user-annotated image data.

In some examples, the workload budget manager determines the number of tiles of the image to process for noise reduction based on a state of battery charge of the image capturing device, a system power budget for the image capturing device, a thermal condition of the image capturing device, and/or a performance condition of the image capturing device.

In some examples, method 1100 is carried out by an image capturing device comprising one or more processors and one or more non-transitory computer readable media storing program instructions executable by the one or more processors. In some examples, the image capturing device is a mobile phone.

In some examples, method 1100 is carried out using one or more non-transitory computer readable media storing program instructions executable by one or more processors, which may be located on and/or remote from an image capturing device.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
applying a human perception model to determine a respective measure of noise perception for each tile of a plurality of tiles of an image captured by an image capturing device;
determining, by a workload budget manager, a number of tiles of the image to process for noise reduction;
selecting at most the determined number of tiles from the plurality of tiles of the image based on the respective measure of noise perception determined for each tile of the plurality of tiles of the image;
applying one or more noise reduction processes to the selected tiles to produce a perception-optimized image; and
causing the image capturing device to display the perception-optimized image.

2. The method of claim 1, wherein selecting at most the determined number of tiles from the plurality of tiles of the image based on the respective measure of noise perception determined for each tile of the plurality of tiles of the image comprises sorting the number of tiles in order based on the respective measure of noise perception determined for each tile of the plurality of tiles of the image.

3. The method of claim 1, wherein the respective measure of noise perception determined for each tile comprises a respective measure of temporal noise, and wherein the one or more noise reduction processes comprises one or more temporal noise reduction processes.

4. The method of claim 1, wherein the respective measure of noise perception determined for each tile comprises a respective measure of spatial noise, and wherein the one or more noise reduction processes comprises one or more spatial noise reduction processes.

5. The method of claim 1, wherein applying the human perception model is based on a measure of luminance of each tile of the plurality of tiles of the image.

6. The method of claim 1, wherein applying the human perception model is based on a measure of contrast of each tile of the plurality of tiles of the image.

7. The method of claim 1, wherein applying the human perception model is based on a measure of motion speed of each tile of the plurality of tiles of the image.

8. The method of claim 1, wherein applying the human perception model is based on a measure of saliency of each tile of the plurality of tiles of the image.

9. The method of claim 1, wherein applying the human perception model is based on a frames per second (FPS) measurement for a display of the image capturing device.

10. The method of claim 1, wherein applying the human perception model is based on a ratio of output to input image resolution.

11. The method of claim 1, wherein applying the human perception model is based on a measure of temporal frequency and a measure of spatial frequency.

12. The method of claim 1, wherein applying the human perception model comprises determining a weighted sum or other function of a plurality of per-tile image measurements.

13. The method of claim 1, wherein applying the human perception model comprises applying a machine learned model to one or more per-tile image measurements, wherein the machine learned model has been trained based on user-annotated image data.

14. The method of claim 1, wherein determining, by the workload budget manager, the number of tiles of the image to process for noise reduction is based on a state of battery charge of the image capturing device.

15. The method of claim 1, wherein determining, by the workload budget manager, the number of tiles of the image to process for noise reduction is based on a system power budget for the image capturing device.

16. The method of claim 1, wherein determining, by the workload budget manager, the number of tiles of the image to process for noise reduction is based on a thermal condition of the image capturing device.

17. The method of claim 1, wherein determining, by the workload budget manager, the number of tiles of the image to process for noise reduction is based on a performance condition of the image capturing device.

18. The method of claim 1, wherein the image capturing device is a mobile phone.

19. An image capturing device comprising one or more processors and one or more non-transitory computer readable media storing program instructions executable by the one or more processors to perform operations comprising:
applying a human perception model to determine a respective measure of noise perception for each tile of a plurality of tiles of an image captured by the image capturing device;
determining, by a workload budget manager, a number of tiles of the image to process for noise reduction;
selecting at most the determined number of tiles from the plurality of tiles of the image based on the respective measure of noise perception determined for each tile of the plurality of tiles of the image;
applying one or more noise reduction processes to the selected tiles to produce a perception-optimized image; and
causing the image capturing device to display the perception-optimized image.

20. One or more non-transitory computer readable media storing program instructions executable by one or more processors to perform operations comprising:
applying a human perception model to determine a respective measure of noise perception for each tile of a plurality of tiles of an image captured by an image capturing device;
determining, by a workload budget manager, a number of tiles of the image to process for noise reduction;
selecting at most the determined number of tiles from the plurality of tiles of the image based on the respective measure of noise perception determined for each tile of the plurality of tiles of the image;
applying one or more noise reduction processes to the selected tiles to produce a perception-optimized image; and
causing the image capturing device to display the perception-optimized image.
